(19) United States
(12) Patent Application Publication
(10) Pub. No.: US 2008/0261568 A1
(43) Pub. Date: Oct. 23, 2008

(54) Methods and systems for providing contact information

(76) Inventors: Matthew G. Lopez, San Diego, CA (US); John C. Santon, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/789,280

(22) Filed: Apr. 23, 2007

(51) Int. Cl. H04M 3/42

(52) U.S. Cl. 455/414.1; 455/557

(57) ABSTRACT

A system includes a communication device comprising a device database of contact information; and a lookup application communicating with the communication device and configured to identify additional contact information in a contact information database that corresponds to a piece of contact information entered into the communication device and to provide the additional contact information to the communication device. A method of providing contact information includes entering a piece of contact information into a communication device; identifying additional contact information that corresponds to the piece of contact information; and providing the additional contact information through the communication device. A system includes a search device for submitting a query regarding a searched business; a server in communication with the search device; and a lookup application resident on the server configured to receive the query and return map data showing a location of the searched business and a location of at least one sponsored business.

### BACKGROUND

Mobile phones typically store a list of names and corresponding phone numbers that have been input by the user. This is usually done by operating the user interface on the mobile phone, including a display device and a numeric key pad that also can be used to input alphabetic characters.

When the user wishes to call a party whose information has been input into the phone, the user can lookup that party, typically by name, in the memory of the phone. Once located, the user can select the entry for that party and initiate a phone call to that party without having to re-enter the party's phone number.

### BRIEF DESCRIPTION OF THE DRAWINGS

The accompanying drawings illustrate various embodiments of the principles described herein and are a part of the specification. The illustrated embodiments are merely examples and do not limit the scope of the specification or claims.

FIG. 1 is a schematic diagram of an exemplary system, according to principles described herein, for providing contact information such as a name and other information associated with a phone number.

FIG. 2 is another schematic diagram of the exemplary system, according to principles described herein, for providing contact information to a communication device.

FIG. 3 is a flowchart illustrating an exemplary method according to principles described herein, for providing contact information, such as a name and other information associated with a phone number.

FIG. 4 is an illustration of an exemplary user interface that, in some examples, is used with the systems described herein.

FIG. 5 is an illustration of an exemplary printout or map hardcopy produced using the exemplary methods and systems described herein.

FIG. 6 is a flowchart illustrating an exemplary method of providing map information utilizing the exemplary systems described herein.

FIG. 7 is an illustration of an exemplary web page or map hardcopy printout produced using the exemplary methods and systems described herein.

Throughout the drawings, identical reference numbers designate similar, but not necessarily identical, elements.

### DETAILED DESCRIPTION

While it is extremely helpful to be able to store a database of names and phone numbers in a mobile phone or other communication device, it may be cumbersome for a user to spend the time inputting all the desired names and phone numbers to the device's database. Consequently, the following specification describes, among other things, various examples of methods and systems that allow the user of a mobile phone or other communication device to input a phone number or other piece of contact information and, based on that information, have the option to automatically add additional corresponding contact information, such as name, address and other pertinent information to the device database from a general directory or other external database.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As used herein and in the appended claims, the term “communication device” will be used broadly to refer to any device with which a user can make a telephone call and that stores a database of phone numbers. Consequently, the term “communication device” includes, but is not limited to, a telephone, including mobile, cellular and satellite phones as well as smart phones incorporating a personal digital assistant (PDA); and computers with Voice over Internet Protocol (VOIP) capability, including both laptop and desktop computers.

As used herein and in the appended claims, the term “search device” will be used broadly to refer to any electronic device with a user interface that can be used to submit a search query to a server so as to obtain from the server the results of the query. Consequently, the term “search device” includes, but is not limited to, a telephone, including mobile, cellular and satellite phones, as well as smart phones incorporating a personal digital assistant (PDA), that can transmit a search query to a server and receive and output the results of the query from the server; and computers, including both laptop, desktop, tablet and palm-top computers and PDAs, that can be used to submit a search query to a server so as to obtain from the server the results of the query.

As used herein and in the appended claims, the term “printer” or “printing device” will be used broadly to refer to any device that produces a hardcopy document from electronic data. Consequently, these terms include, but are not limited to, laser printers, inkjet printers, digital copiers, multifunction peripherals, facsimile machines, etc.

As used herein and in the appended claims, the term “contact information” will be understood to broadly mean any one or more of the following, name, phone number, fax number, mobile phone number, address, email address, employer, website address, domain name, etc.

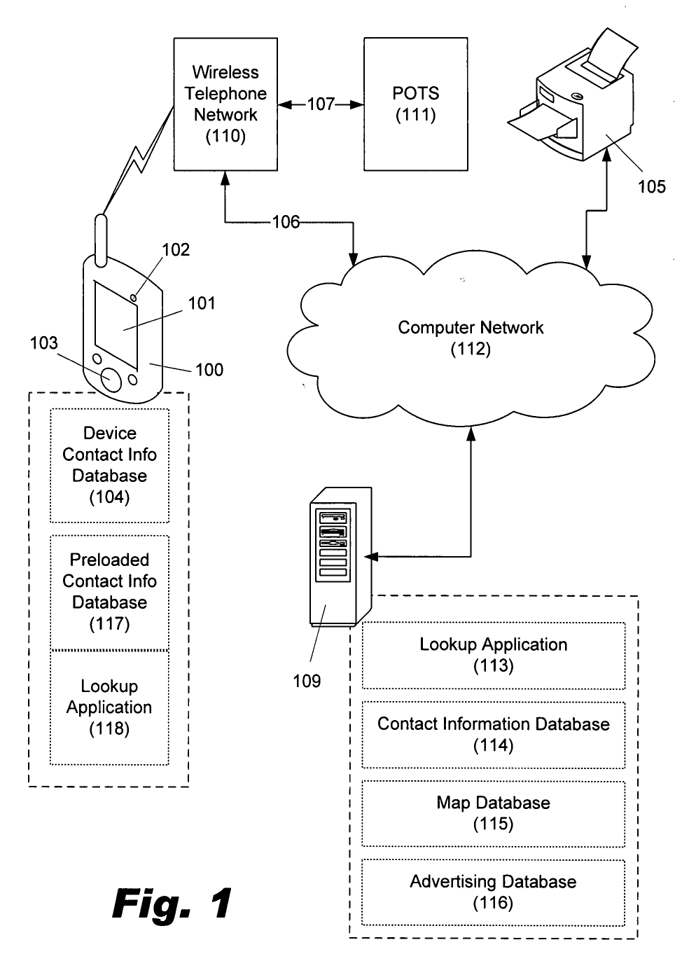

FIG. 1 is a schematic diagram of an exemplary system, according to principles described herein, for providing contact information such as a name and other information associated with a phone number. As described above, there are a variety of communication devices with which a user can make a telephone call. In the example illustrated in FIG. 1, the communication device being used is a telephone (100). This telephone (100) may be, in some examples, a mobile, cellular or satellite phone. Additionally, the telephone (100) may be a smart phone incorporating the functionality of a personal digital assistant.

As shown in FIG. 1, the phone (100) includes a database (104) of contact information, also referred to as the device database. In some examples, the device database (104) may simply store corresponding names and phone numbers. In other examples, each entry in the device database (104) may include a larger array of contact information for the listed party, such as name, phone number, email address, other phone numbers, fax number, address, map data and similar information.

The phone (100) also includes a user interface to allow the user to access the data in the device database (104) and to make phone calls. In the example of FIG. 1, the user interface includes a display device (101) on which data from the device database (104) can be displayed. In some examples, the display device (101) may be a touch-sensitive display with which a user can lookup data in, or input data to, the device database (104). Additionally or alternatively, the user interface may include a keypad of numeric or alphanumeric keys. The user interface also includes a speaker (102) and microphone (103) with which a user can conduct a telephone call.

In the example of FIG. 1, the phone (100) is a wireless phone that communicates with a wireless telephone network (110). The wireless phone may be a mobile phone, a cellular phone or a satellite phone, for example. The wireless telephone network (110) is connected (107) with the public telephone system or Plain Old Telephone System (POTS) (111). Consequently, calls made from the wireless phone (100) can be directed to any phone, whether wireless or wired, that is accessible to the POTS (111).

The wireless telephone network (110) may also provide a connection (106) to a computer network (112) from which data can be served to the wireless phone (100). The computer network (112) can be a local area or wide area network affiliated with the wireless telephone network (110) or may be a global computer network, such as the Internet.

In the example of FIG. 1, the computer network (112) includes a server (109). This server (109) stores or has access to a contact information database (114), a map database (115) and an advertising database (116). As will be appreciated by those skilled in the art, the server (109), while illustrated as a single device, may alternatively represent a number of different device configurations, such as, a collection of servers providing the desired information databases.

For example, any or all of the contact information database (114), map database (115) and advertising database (116) may be located on a different server in different locations or at different network addresses. In other examples, any or all of the three databases may be divided among two or more different servers or have portions resident at different network addresses.

The server (109) also includes a lookup function or application (113) that manages the contact information database (114), the map database (115) and the advertising database (116). If any of the databases (114, 115, 116) is distributed over a number of different servers or network addresses, the lookup application (113) will coordinate, search and compile data from the various components of the databases (114, 115, 116) as needed.

In particular, the lookup application (113) includes a reverse lookup functionality in which, based on a phone number, the lookup application (113) will use the contact information database (114) to identity a name corresponding to that phone number. The lookup application (113) may also identify an address and/or other contact information that corresponds to the phone number in question. Using the map database (115), the lookup application (113) may also retrieve or formulate a map that includes the address corresponding to the phone number in question. The various operations of the lookup application (113) will be discussed in more detail below.

In the example of FIG. 1, the system includes a printer (105). The printer (105) may be connected to the computer network (112) and may receive print jobs from print clients via the network (105). As will be explained below, the printer (105) may be employed to print a map or other data produced by the lookup application (113) on the server (109).

As seen in FIG. 1, the phone (100) may have a connection to the printer (105) through the wireless telephone network (110) and the computer network (112). In some embodiments, there may be a more direct connection between the phone (100) and the printer (105). In either case, the phone (100) may submit a print job, perhaps including data served up by the server (109), to the printer (105).

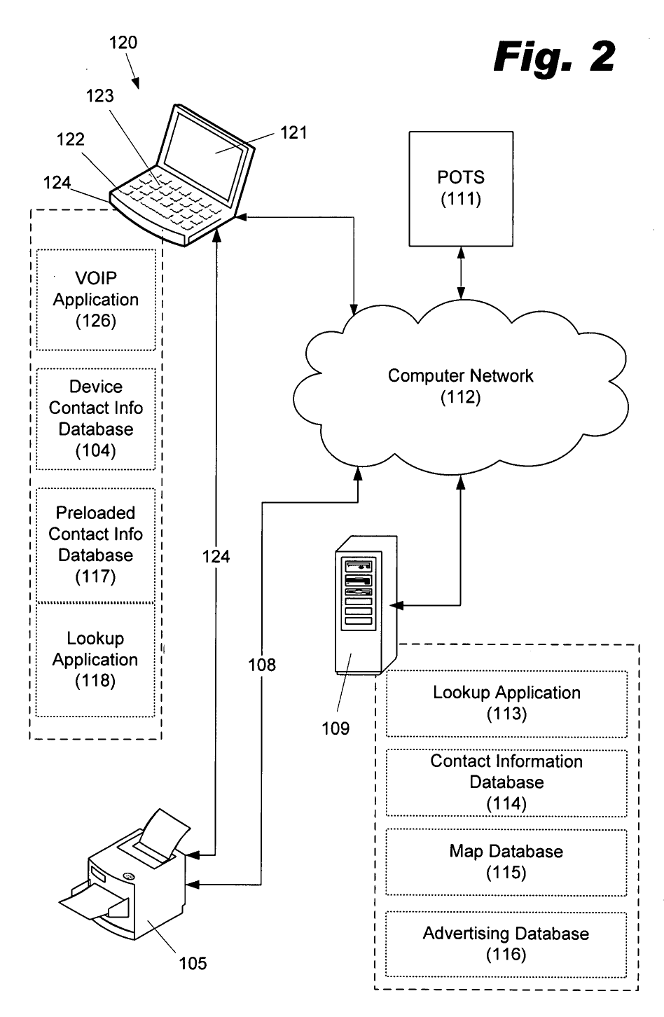

FIG. 2 is another schematic diagram of the exemplary system, according to principles described herein, for providing contact information. In the example of FIG. 2, the communication device being used is a computer, for example, a laptop computer (120).

The computer (120) includes a user interface. For example, the user interface includes a screen, display or monitor (121) and a keyboard with a trackpad or mouse (123). The user interface also includes a speaker (124) and microphone (122) so that the computer (120) can produce and relay the audio of a phone call between two parties, one of which is using the computer (120).

The computer (120) includes a Voice over Internet Protocol (VOIP) application (126). The VOIP application (126) receives audio that is spoken by the user of the computer and transduced into an electronic signal by the microphone (122). The VOIP application (126) converts that audio into digital data packets and that can be transferred using Internet Protocol (IP) over the computer network (112) to a recipient. The recipient may be another computer user on the network (112) or may be a telephone connected to the POTS (111), including wireless telephone networks connected to the POTS (111).

The VOIP application (126) also receives incoming audio data packets from the other party to the phone call. The VOIP application (126) uses those data packets to reproduce the sound of the voice of the other party to the phone call using the speaker (124) of the computer (120).

The computer (120) also includes a contact information or device database (104). As described above, this database (104) may simply store corresponding names and phone numbers. In other examples, each entry in the device database (104) may associate a larger array of contact information for the listed party, such as name, phone number, email address, other phone numbers, fax number, address, web address, map data and similar information.

As described above, the system may also include a printer (105). The printer (105) is connected to the system through the computer network (112). Alternatively or additionally, there may be a local connection (124) between the computer (120) and the printer (105).

As shown in either FIG. 1 or FIG. 2, the communication device, e.g., the phone (100) or the computer (120), may include a preloaded contact information database (117). This database may provide a database of contact information similar to the contact information database (114) of the server (109). In other words, the preloaded contact information database (117) may provide all the residential and business listings for a specific locality or geographic region. For example, 100 million contact entries (including phone number, name, and address) could be stored in approximately 700 Megabytes of uncompressed memory.

While the preloaded contact information database is not used as the device contact info database that is specifically built by the user to contain that information the user selects, the preloaded contact information database (117) can be used to provide information for the device contact information database (104) in the same manner as the server's (109) contact information database (114) described above.

For example, a lookup application (118) as shown in either FIG. 1 or FIG. 2 that is loaded on the communication device (100, 120) may accept a phone number or other piece of initial contact information input by the user into the communication device (100, 120) and search the preloaded contact information database (117) for additional corresponding contact information that can be provided to the user and entered into the device contact information database (104) as the user chooses. In other embodiments, the lookup application (118), when executed, may automatically search each entry in the device contact information database (104) and supplement each entry with additional corresponding pieces of contact information from that preloaded database (117).

In this way, the communication device (100, 120) would not need to be connected to the network (112) and server (109) to obtain additional contact information based on an initial known piece of contact information. Additionally, the addition contact information can be served up relatively quickly since it is already resident in the memory of the communication device (100, 120)

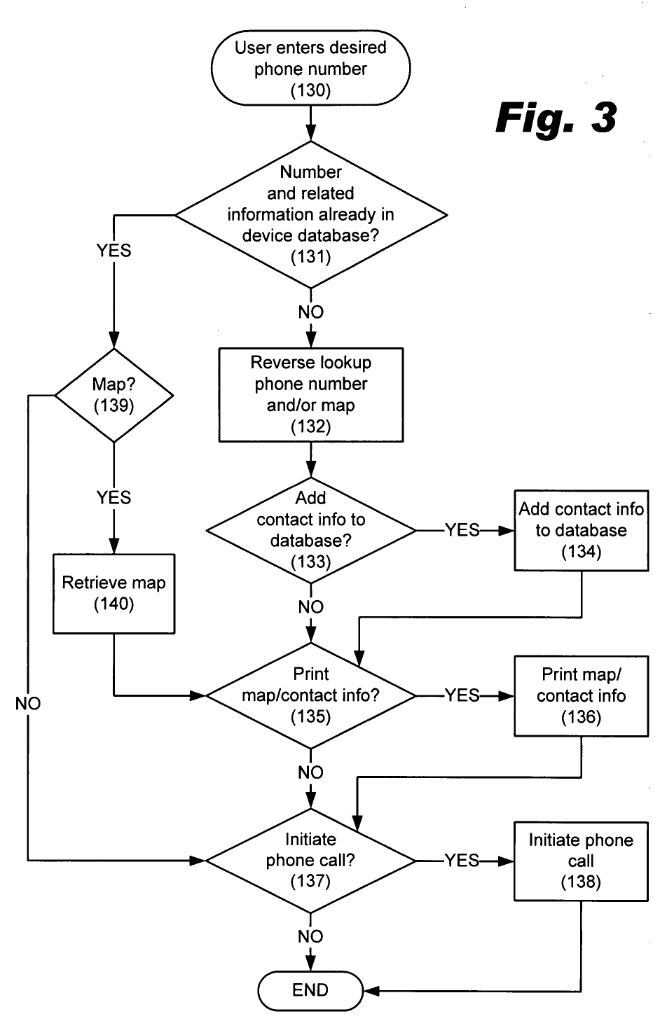

The various uses of the exemplary systems illustrated in FIGS. 1 and 2 will now be explained with reference to the flowchart of FIG. 3.

FIG. 3 is a flowchart illustrating an exemplary method according to principles described herein, for providing contact information. As shown in FIG. 3, the method begins when the user of a communication device enters a phone number into that device (step 130). The device then determines whether that phone number is already contained in the device database (determination 131).

If the phone number is not already stored in the device database or if some desired contact information is missing from the entry corresponding to the phone number in the device database (determination 131), the device may automatically seek additional contact information corresponding to the phone number. In some examples, the device may contact the server (109, FIGS. 1 and 2) and provides the phone number to the server. The server then performs a reverse lookup using the phone number (step 132). In other embodiments, a preloaded contact information database (117, FIGS. 1 and 2) may be queried for additional contact information corresponding to the phone number (step 132). As a result of the reverse lookup, a name (perhaps a business name), an address and possibly other contact information may be identified that correspond to the phone number the user has entered. In some embodiments, the server will also produce a map including the address corresponding to the phone number and the surrounding vicinity using the map database (115, FIGS. 1 and 2).

The contact information matching the phone number is then provided to the user, e.g., returned to the communication device of the user. The user may then be given the option of adding this corresponding contact information to the device database on the communication device (determination 133). If the user accepts the information, the contact information is added to the database (step 134). In this way, the user can build the device database by only inputting phone numbers without having to input all the contact information associated with that phone number.

Those of skill in the art will also appreciate that the system and method described herein can use any initial piece of contact information, not just a phone number, as the starting point for a lookup operation. For example, the user may enter an address into the communication device and have the lookup application (113, FIGS. 1 and 2) produce the corresponding name and phone number associated with that address. Similarly, the user may enter a name into the communication device and have the lookup application (113, FIGS. 1 and 2) produce corresponding phone numbers and addresses associated with that name. Any piece of contact information can be used as the search criteria with the lookup application (113, FIGS. 1 and 2) using that information to locate other corresponding pieces of contact information.

In some examples, there may be more than one person or entity with the same piece of contact information, such as the same name. Where this is the case, there may be multiple listings returned in response to such a search from among which the user can select the desired entity and corresponding contact information.

If the server (109, FIGS. 1 and 2) has also provided or offered a map corresponding to the contact information of the search, the user of the communication device can decide whether to print the map (determination 135). In some examples, the map may be printed with some or all of the other contact information listed thereon. In other examples, only textual contact information without a map may be selected for printing.

Additionally, in some examples, advertising from the advertising database (116, FIGS. 1 and 2) may be added to the map, either as printed by the printer (105, FIGS. 1 and 2) or as displayed on the communication device. This advertising may be an advertisement printed or display on or to the side of the map. The advertising may be related to the business that is being mapped or to businesses in the vicinity of the mapped business as discussed in more detail below.

If the user selects printing (determination 135), the map and/or contact information, and perhaps advertising, are sent to the printer (105, FIGS. 1 and 2) (step 136). In this way, the user may quickly obtain a printed map of a location he or she intends to visit having started only with, for example, a phone number corresponding to the address on the map.

Whether or not additional contact information is received into the device database, and whether or not a map is generated and printed, the user can initiate a phone call (determination 137) to the phone number entered in step 130. If the user desires, the phone call to that number is initiated (step 138).

In some cases, the user may enter a phone number for which contact information, not including a map, is already stored in the device database (determination 131). Where this is the case, the method of FIG. 3 may still allow the user to obtain a map of the address and surrounding vicinity corresponding to the phone number that has been entered.

If a map is desired (determination 139), the map is retrieved (step 140). This is done using the connection to the server (109, FIGS. 1 and 2) with the map database (115, FIGS. 1 and 2) as described above. The map can then be printed (determination 135) as desired.

As also shown in FIG. 3, the user can, with or without retrieving and printing the map, initiate a phone call (determination 137) to the entered phone number (step 138).

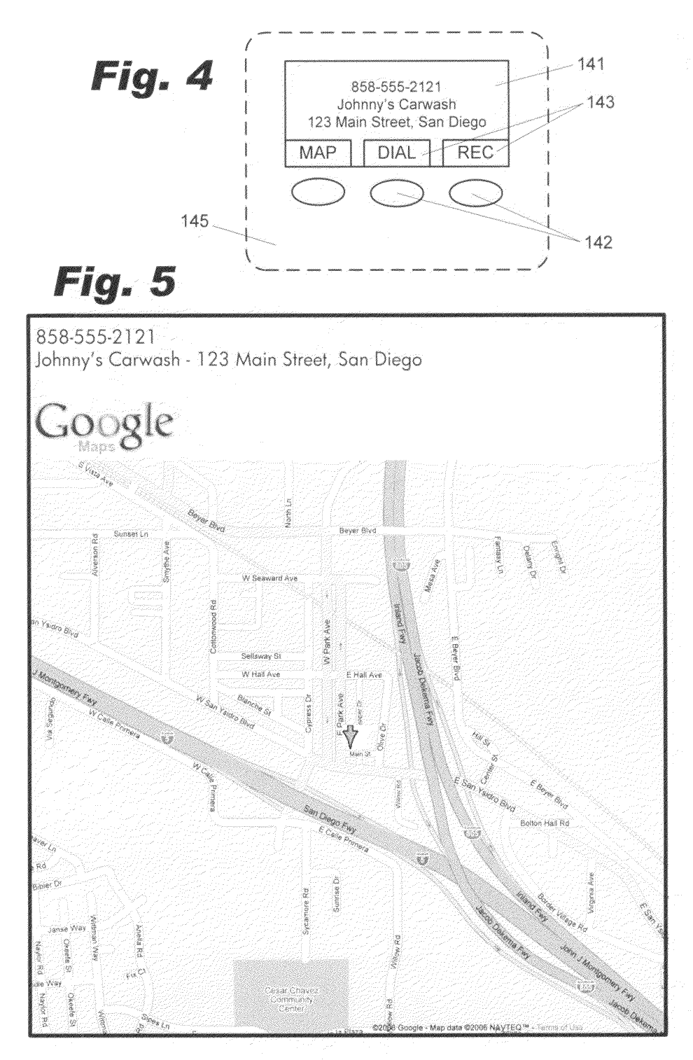

FIG. 4 is an illustration of an exemplary user interface that, in some examples, is used with the systems described herein. As shown in FIG. 4, the communication device (145) includes a display (141). In the example of FIG. 4, the user has input a phone number. The phone number has been searched by the server (109, FIGS. 1 and 2) as described above, which search has returned a business name and address corresponding to the entered phone number.

As indicated in the discussion above, the user can record the contact information in the device database, generate a map including the indicated address and/or initiate a phone call to the number. Accordingly, the interface shown in FIG. 4 displays three soft-buttons (143) on the display device (141) corresponding to these options. As shown in FIG. 4, buttons labeled “MAP,” “DIAL” and “REC” are displayed on the display device (141) of the communication device (145).

If the display (141) is a touch-sensitive display, the desired button may be selected by tapping the displayed button on the display device (141) with a finger or stylus. Alternatively, hard buttons (142) may be positioned below the display (141) in alignment with the displayed labels “MAP,” “DIAL” and “REC.” In such an example, the hard button below the desired option is pressed to select that option.

If the MAP option is selected, the server (109, FIGS. 1 and 2) is signaled to provide a map. If the DIAL option is selected, a phone call is initiated to the number indicated. If the REC option is selected, the contact information provided that includes and corresponds to the entered phone number, or other starting piece of contact information, is recorded in the device's contact information database (104, FIGS. 1 and 2).

As described above, when a map is generated to show the location and surrounding vicinity of an address, that map can be printed by the system for reference by the user. FIG. 5 is an illustration of an exemplary map hardcopy printed using the exemplary methods and systems described herein.

As shown in FIG. 5, the map may be centered on the address in question and show the surrounding vicinity. The printout may also include the text of the phone number, name and/or address of the party. In some embodiments, the map may also show directions from a starting point to the address being mapped, e.g., the address corresponding to the phone number entered by the user. These directions may be turn-by-turn directions and may include GPS data or data that can be provided to a GPS unit.

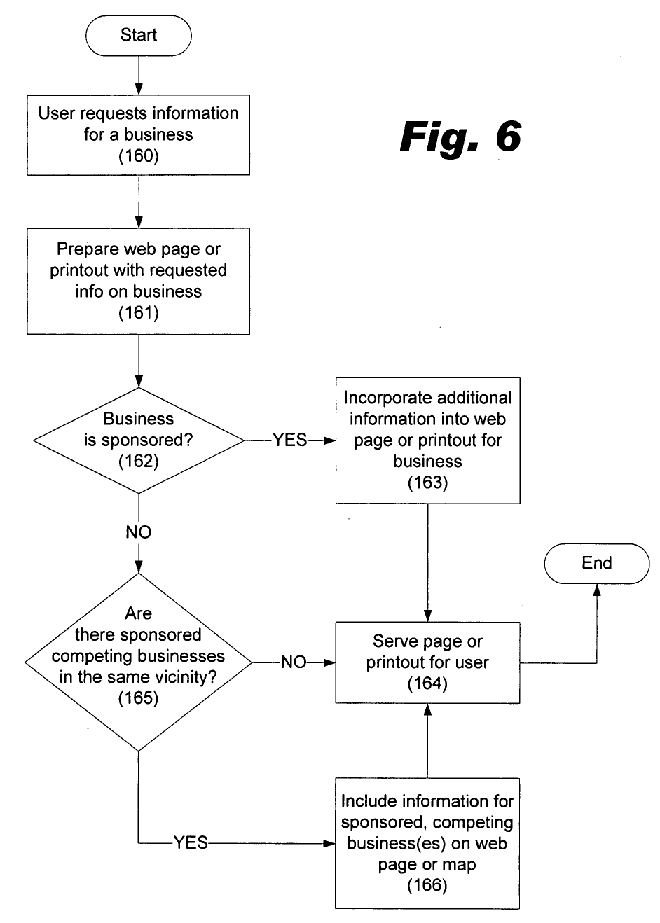

FIG. 6 is a flowchart illustrating an exemplary method of providing map information with the exemplary systems described herein. As shown in FIG. 6, the exemplary systems described herein can also be used to provide advertising opportunities for sponsored businesses.

As used herein and in the appended claims, the term “sponsored business” refers to any business or organization that had paid a fee to have its contact information or promotional advertising provided to system users under appropriate circumstances. Accordingly, in such embodiments, the advertising or promotional information collected from sponsored businesses will be used to populate the advertising database (116, FIGS. 1 and 2) described above.

As used herein and in the appended claims, the term “searched business” will be used to refer to a business for which a user is searching for additional contact information and for which the user has submitted a query to the system using some piece of contact information for that searched business from which any additional corresponding contact information for the business is to be identified. A searched business may or may not be a sponsored business.

As used herein and in the appended claims, the term “competing business” will be used to refer to a business which is in the same line of business or a related business as a searched business about which a user has entered a query or search. For example, if the user searched for a restaurant, a competing business may be a different restaurant in the same geographic area. A competing business may also be a sponsored business.

As noted above, when a user requests information about a business, advertising from the advertising database (116, FIGS. 1 and 2) may be provided to the user along with the requested information. In the embodiments described above, the advertising provided may be related to the business about which the user has queried, may be advertising for competing sponsored businesses or may be unrelated to the user's query.

The method of FIG. 6 begins when a user requests information for a business (step 160). This request or search query may be made with a search device or communication device as described above, such as a computer or a phone. The request may be in any of a variety of forms. For example, as described above, the request may be the entry of a phone number for the business in questions with no other search criteria. In other examples, the request may be the name of the business being searched, with or without reference to a specific locale, such as a city or state. The search can be based on any identifying contact information of the searched business.

As shown in FIG. 6, the server (109, FIGS. 1 and 2) will access the various databases described above to obtain additional contact information for the user corresponding to the searched business (step 161). This information may be prepared for printing as a hardcopy, displayed on the communication or search device as a web page, or both. The information may include a map showing the searched business and the vicinity around the searched business as described above.

Next, in the example of FIG. 6, the server (109, FIGS. 1 and 2) will determine whether the business being searched by the user is a sponsored business (determination 162), e.g., whether the searched business has paid a promotional fee to the system operator. If the searched business is a sponsored business (determination 162), then the server (109, FIGS. 1 and 2) may incorporate additional information, such as advertising, into the web page or printout being prepared for the user (step 163). The advertising used may be taken from the advertising database (116, FIGS. 1 and 2) and may include, for example, special sales or deals at the sponsored business, coupons to be used at the sponsored business, product or service reviews for the sponsored business, or any other advertising or promotional information regarding the sponsored business.

Once the additional information for the sponsored business has been incorporated, the web page or printout is served to the user (step 164). This may include transmitting to and displaying a web page on the user's communication or search device that includes, for example, any of contact information for the searched/sponsored business, advertising information for the business, a map to the business location and surrounding area or any other information about the searched/sponsored business. In some examples, because the business is a sponsored business, no information that is not related to that specific business will be included in the web page or printout.

Once displayed, the web page may be printed by the user of the communication or search device. Alternatively, a printout may be served that is sent directly to the printer (105, FIGS. 1 and 2) or that is sent automatically to the printer in addition to being transmitted to and displayed on the user's communication or search device.

If the searched business is not a sponsored business (determination 162), the server (109, FIGS. 1 and 2) will, in addition to preparing the web page or printout with information on the searched business, determine whether there are sponsored competing businesses in the same vicinity as the searched business (determination 165). As indicated, the competing business or businesses so identified may be those that are in the same business or a related business as the searched business.

If no sponsored, competing businesses are in the vicinity of the searched business (determination 165), the web page or printout is served up to the user as described above. However, if there is a sponsored, competing business or businesses in the vicinity of the non-sponsored, searched business, the server (109, FIGS. 1 and 2) may include additional information on the web page or printout relating to the sponsored competing business or businesses in the vicinity of the searched business (step 166). This may include providing advertising for the competing business from the advertising database (116, FIGS. 1 and 2), contact information for the competing business, a hyperlink to a website for the competing business or other information related to the competing business on the web page or printout served to the user (step 164).

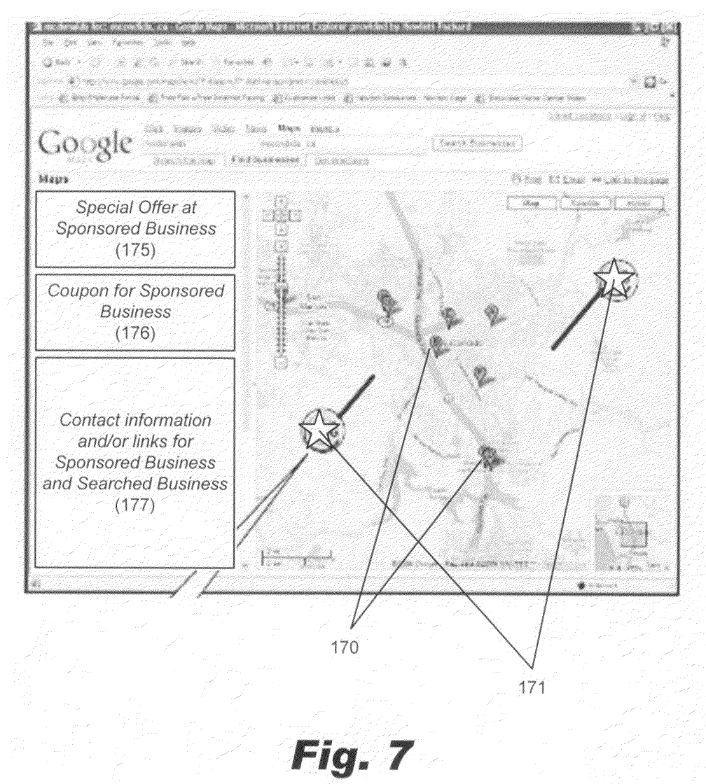

FIG. 7 is an illustration of an exemplary web page or map hardcopy produced using the exemplary methods and systems described herein. With reference to the exemplary method described above in connection with FIG. 6, FIG. 7 shows an example of the results of a user query.

In the example of FIG. 7, the searched business was not a sponsored business. Nevertheless, the location of the searched business is shown on the map (170). In the present example, the searched business has branches or franchises at multiple locations in the indicated vicinity as shown in FIG. 7. Additionally, contact information for the searched business (177) may be included.

Because the searched business is not a sponsored business, the system has also located competing, sponsored businesses in the vicinity. The location or locations (171) of these sponsored businesses are indicated on the map of FIG. 7. In some examples, the indicator (171) for the sponsored business on the map may be the logo of that business. Contact information for the sponsored business or businesses (177) may also be included.

Additionally, advertising for the sponsored business or businesses may be included. In the example of FIG. 7, an advertisement (175) of a special offer or a sale is included along with the map. Additionally or alternatively, a coupon (176) that can be used at the sponsored business or businesses is included. If the map of FIG. 7 is printed, the coupon (176) is then available to be redeemed at the participating business.

Using the systems and methods described above, users of the system are encouraged to patronize sponsored businesses. This provides an incentive for business to become sponsored by paying promotional fees to the system operator.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system comprising:
a communication device comprising a device database of contact information; and
a lookup application communicating with said communication device and configured to identify additional contact information in a contact information database that corresponds to a piece of contact information entered into said communication device and to provide the additional contact information to said communication device.

2. The system of claim 1, comprising a server in communication with said communication device, said server comprising said lookup application and said contact information database.

3. The system of claim 1, wherein said lookup application and said contact information database are resident on said communication device.

4. The system of claim 1, wherein said communication device comprises a telephone.

5. The system of claim 1, wherein said communication device comprises a computer with a Voice over Internet Protocol application.

6. The system of claim 1, further comprising a printer in communication with said server or said communication device for printing said contact information.

7. The system of claim 2, further comprising a map database accessible to said server, wherein said additional contact information comprises a map.

8. The system of claim 2, further comprising an advertising database accessible to said server, wherein advertising from said advertising database is included by said server with said additional contact information transmitted to said communication device.

9. A method of providing contact information, said method comprising:
entering a piece of contact information into a communication device;
identifying additional contact information that corresponds to said piece of contact information; and
providing said additional contact information through said communication device.

10. The method of claim 9, further comprising printing a hardcopy of at least some of said additional contact information.

11. The method of claim 10, wherein said additional contact information comprises a map.

12. The method of claim 9, further comprising transmitting advertising along with said additional contact information to said communication device.

13. The method of claim 9, further comprising storing said additional contact information in a device contact information database of said communication device.

14. A system comprising:
a search device for submitting a query regarding a searched business;
a server in communication with said search device; and
a lookup application resident on said server configured to receive said query and return map data showing a location of said searched business and a location of at least one sponsored business.

15. The system of claim 14, wherein said search device comprises a communication device.

16. The system of claim 14, wherein said lookup application returns a map showing the location of said searched business if said searched business is a sponsored business.

17. The system of claim 14, wherein said lookup application returns a map showing the location of said searched business and a location of at least one competing sponsored business if said searched business is not a sponsored business.

18. The system of claim 14, wherein said lookup application also returns advertising corresponding to said at least one sponsored business with said map data to said search device.

19. The system of claim 14, wherein a logo of said sponsored business is used to indicate a location of said sponsored business in said map data.

20. The system of claim 14, further comprising a printer for printing data generated by said lookup application.
